(19) United States
(12) Patent Application Publication
(10) Pub. No.: US 2010/0164954 A1
(43) Pub. Date: Jul. 1, 2010

(54) Tessellator Whose Tessellation Time Grows Linearly with the Amount of Tessellation

(76) Inventors: Rahul P. Sathe, Hillsboro, OR (US); Paul A. Rosen, West Lafayette, IN (US)

Correspondence Address: TROP, PRUNER & HU, P.C., 1616 S. VOSS RD., SUITE 750, HOUSTON, TX, 77057-2631, US

(21) Appl. No.: 12/347,114

(22) Filed: Dec. 31, 2008

(51) Int. Cl. G06T 17/20; G06F 15/16

(52) U.S. Cl. 345/423; 345/502

(57) ABSTRACT

In accordance with some embodiments, a tessellator may experience only a linear increase in tessellation time with increasing edge levels of detail. Conventionally, tessellators experience a non-linear or quadratic increase in tessellation time with increasing levels of detail. In some embodiments, the intervals and the triangulation of the inner tessellation may be pre-computed. Then at run time, the pre-computed values may be looked up for the applicable edge level of detail.

### BACKGROUND

This relates generally to graphics processing, including the use of graphics processors and general purpose processors used for graphics processing.

The graphics pipeline may be responsible for rendering graphics for games, computer animations, medical applications, and the like.

The level of detail of the graphics images that are generated may be less than ideal due to limitations in the graphics pipeline. The greater the detail that is provided, the slower the resulting graphics processing. Thus, there is a tradeoff between processing speed and graphics detail. New graphics processing pipelines, such as Microsoft® DirectX 11, increase the geometric detail by increasing the tessellation detail.

Tessellation is the formation of a series of triangles to render an image of an object starting with a coarse polygonal model. A patch is a basic unit at the coarse level describing a control cage for a surface. A patch may represent a curve or region. The surface can be any surface that can be described as a parametric function. A control cage is a low resolution model used by artists to generate smooth surfaces.

Thus, by providing a higher extent of tessellation, the level of graphical detail that can be depicted is greater. However, the processing speed may be adversely affected. In general, the processing time increases quadractically with increased image level of detail.

### BRIEF DESCRIPTION OF THE DRAWINGS

FIG. 1 is a schematic depiction of a graphics pipeline in accordance with one embodiment;

FIG. 2 is a depiction of an inner tessellation with a maximum inner tessellation factor reduction function and a 1-axis inner tessellation factor axis reduction according to one embodiment;

FIG. 3 is a depiction of a tessellation pattern with an average inner tessellation factor reduction function and 1-axis inner tessellation factor axis reduction according to one embodiment;

FIG. 4 is a depiction of a tessellation pattern for a 1-axis tessellation using a minimum inner tessellation factor reduction function according to one embodiment;

FIG. 5A is a depiction of a 1-axis inner tessellation factor axis reduction according to one embodiment;

FIG. 5B is a 1-axis inner tessellation where the top edge has a different edge level of detail than in FIG. 5A according to one embodiment;

FIG. 5C is a 1-axis inner tessellation where the left edge has a different edge level of detail than the tessellations shown in FIGS. 5A and 5B according to one embodiment;

FIG. 6 is a hypothetical graph of cycles per patch versus the level of detail showing the effect for a non-linear relationship and a linear relationship using a 1-axis, power 2 tessellation on a software tessellator in accordance with one embodiment;

FIG. 7 is a flow chart for one embodiment of the present invention; and

FIG. 8 is a schematic depiction of a multi-core processor according to one embodiment.

### DETAILED DESCRIPTION

In accordance with some embodiments, tessellation time increases only linearly with the amount of tessellation. Conventionally, tessellation time grows as a quadratic function with the amount of tessellation detail. As a result, in some embodiments, tessellation time may be decreased and, in other embodiments, less powerful tessellators can be used to perform more detailed tessellations.

In some embodiments, the tessellation time may be saved and/or tessellation processing capability may be increased by pre-computing a series of pre-computed inner tessellations over a range of edge level of detail. This saves re-computing the inner tessellations at run time.

In accordance with some embodiments, the tessellation may use a triangular or quad primitive domain. Edge partitioning may involve dividing the edges into intervals. The more intervals that are used the higher level of detail of tessellation that is possible. Thus, increasing the edge level of detail may increase the resolution of the resulting tessellation.

The inner tessellation is the tessellation of primitive points inside the outer perimeter of the primitive. The outer band is made up of the perimeter of the primitive.

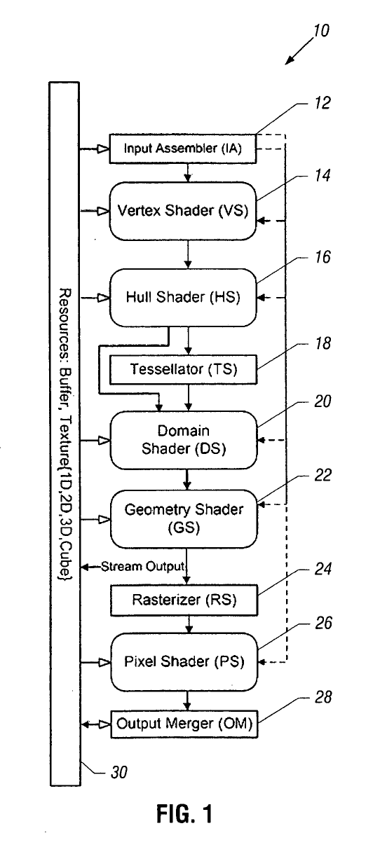

Referring to FIG. 1, a graphics pipeline may be implemented in a graphics processor as a standalone, dedicated integrated circuit, in software, through software implemented general purpose processors or by combinations of software and hardware.

The input assembler 12 reads vertices out of memory using fixed function operations, forming geometry, and creating pipeline work items. Auto generated identifiers enable identifier-specific processing, as indicated on the dotted line on the right in FIG. 1. Vertex identifiers and instance identifiers are available from the vertex shader 14 onward. Primitive identifiers are available from the hull shader 16 onward. The control point identifiers are available only in the hull shader 16.

The vertex shader 14 performs operations such as transformation, skinning, or lighting. It inputs one vertex and outputs one vertex. In the control point phase, invoked per output control point and each identified by a control point identifier, the vertex shader has the ability to read all input control points for a patch independent from output number. The hull shader 16 outputs the control point per invocation. The aggregate output is a shared input to the next hull shader phase and to the domain shader 20. Patch constant phases may be invoked once per patch with shared read input of all input and output control points. The hull shader 16 outputs edge tessellation factors and other patch constant data. As used herein, edge tessellation factor and edge level of detail with a number of intervals per edge of the primitive domain may be used interchangeably. Codes are segmented so that independent work can be done with parallel finishing with a join step at the end.

The tessellator 18 may be implemented in hardware or in software. In some advantageous embodiments, the tessellator may be a software implemented tessellator. By speeding up the operation of tessellator, as described herein, the cores that were doing tessellator operations may be freed up to do other tasks. The tessellator 18 may input, from the hull shader, numbers defining how much to tessellate. It generates primitives, such as triangles or quads, and topologies, such as points, lines, or triangles. The tessellator inputs one domain location per shaded read only input of all hull shader outputs for the patch in one embodiment. It may output one vertex.

The geometry shader 22 may input one primitive and outputs up to four streams, each independently receiving zero or more primitives. A stream arising at the output of the geometry shader can provide primitives to the rasterizer 24, while up to four streams can be concatenated to buffers 30. Clipping, perspective dividing, view ports, and scissor selection implementation and primitive set up may be implemented by the rasterizer 24.

The pixel shader 26 inputs one pixel and outputs one pixel at the same position or no pixel. The output merger 28 provides fixed function target rendering, blending, depth, and stencil operations.

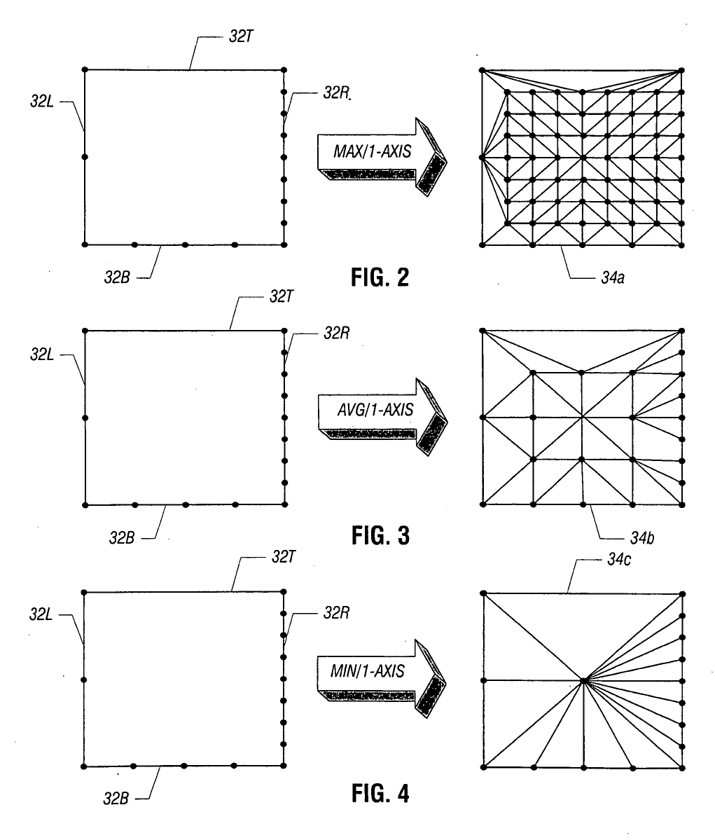

Thus, referring to FIG. 2, according to an embodiment where the primitive is a quad, a quad 32 has a top side 32t, a right side 32r, a bottom side 32b, and a left side 32l. In this example, the top side 32t has one interval, the right side 32r has eight intervals, the bottom side 32b has four intervals, and the left side 32l has two intervals. The intervals correspond to the edge level of detail and the tessellation factor. In the tessellator 18, an inner tessellation may use a factor reduction function of either minimum, maximum, or average. FIG. 2 shows a maximum reduction function. In this case, the tessellation is implemented using the edge 32r because it has the maximum number of intervals. It calculates only one maximum in this embodiment. In other embodiments, a triangle can be used as the primitive and other inner tessellation reduction functions may be used.

FIG. 3 shows a quad after processing with an average tessellation factor reduction function. Here, an average is based on the average of the intervals of the four sides. Finally, FIG. 4 shows the result of the minimum tessellation reduction factor uses the minimum side, which would be the top side 32t.

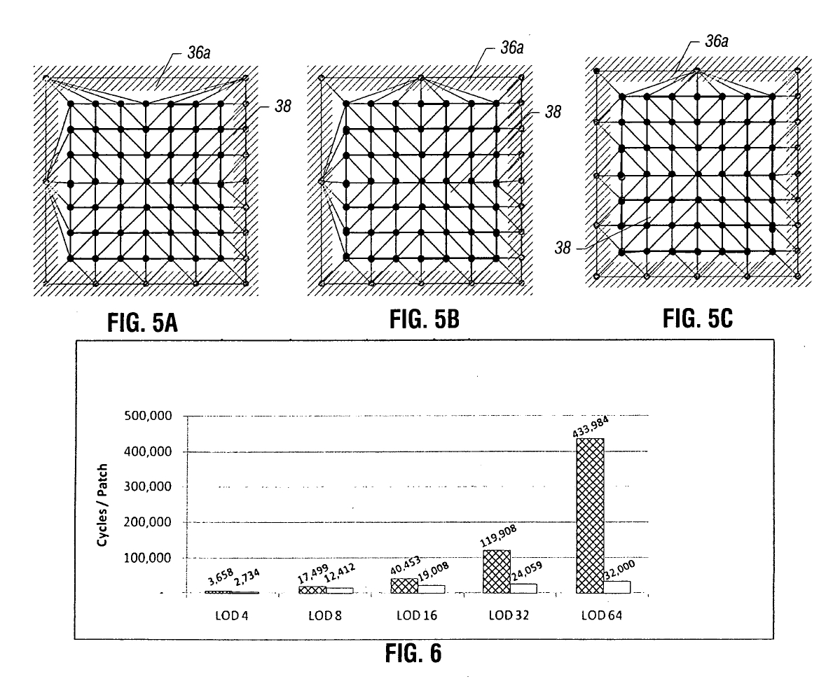

Referring next to FIGS. 5A-5C, the quad can be divided into an outer band 36a and an inner tessellation 38. The outer band 36a is everything along the perimeter of the primitive domain, in this case a quad, and the inner tessellation is everything else. FIGS. 5A-5C show that in a 1-axis inner tessellation factor reduction example, the inner tessellation is the same, regardless of the number of intervals used in the outer band as long as the maximum of the outer tessellations remain the same. In this example, the tessellation factor reduction function is the maximum and the tessellation factor axis reduction is 1-axis. Thus, regardless of the edge level of detail or tessellation factor, the inner tessellation remains the same. As a result, it is possible to pre-compute the inner tessellations for a variety of different edge level of detail, store them, and simply apply them when needed during run time. Thus, the pre-computed inner tessellations for a range of edge level of detail may be reused and need not be recalculated at run time, speeding the calculation.

Referring to FIG. 6, the tessellation time increases linearly with increasing tessellation detail, as indicated by the cross-hatched bars, using an embodiment of the present invention. However, with other techniques, the tessellation time grows non-linearly or quadratically with increasing tessellation detail, as indicated by the hatched bars. The example shown in FIG. 6 uses 1-axis tessellation reduction using power 2 edge partitioning and maximum tessellation factor reduction functions. In this example, a software-based tessellation was used. Thus, as the level of detail increases, the number of cycles per patch increases to a greater extent in the non-linear example, but increases linearly in the example in accordance with one embodiment of the present invention. With some hardware-based approaches, the differences between pre-computed inner tessellations and non-pre-computed inner tessellations may be less dramatic.

Referring to FIG. 7, in accordance with one embodiment of the present invention, the tessellator 18 begins by pre-computing and storing the u and the v values for the inner tessellation, as indicated in block 40. The u and v values are simply the coordinates or intervals of the points, as depicted, for example, in FIG. 5A, along the horizontal axis u and the vertical axis v. Also, the triangulation may be pre-computed for the inner tessellation, as indicated in block 42, and stored. Thus, in one embodiment, for all of the different edge levels of detail, a pre-computed value of the various points and the resulting triangulation for the inner tessellation may be predetermined and stored. Then at run time the u, v, values along the primitive outer band are calculated, as indicated in block 44. Also, the triangulation for the outer band is calculated, as indicated at block 46, during run time. Then, during run time, the tessellator 18 looks up the appropriate pre-computed values for the inner tessellations based on the applicable level of detail.

Thus, in some embodiments such as DirectX 11, there are only 64 discrete edge levels of detail. Other embodiments may use other numbers of edge levels of detail. The inner tessellation may be pre-computed for each of these edge levels of detail and stored for use at run time.

During run time, when an image is being processed, different edge levels of detail may be specified for different regions of the image. Typically, things closer to the camera (and, hence, the ones occupying larger screen space) will be tessellated more than the ones farther away from the camera. Thus, in an animation where a punch is thrown, the level of detail for the first may be highest and the regions away from the first may use lower level of detail. Thus, a relatively realistic rendering can be created because users may not notice the different levels of detail used in regions of less interest within the depiction. As a result, a wide variety of edge levels of detail may be encountered. Instead of calculating each of these levels of detail for the inner tessellation at run time as they arise, they may all be pre-computed, in some embodiments, and then looked up at run time and simply used without delaying the run time calculation with determining the values of the inner tessellation points and connectivity or triangulation.

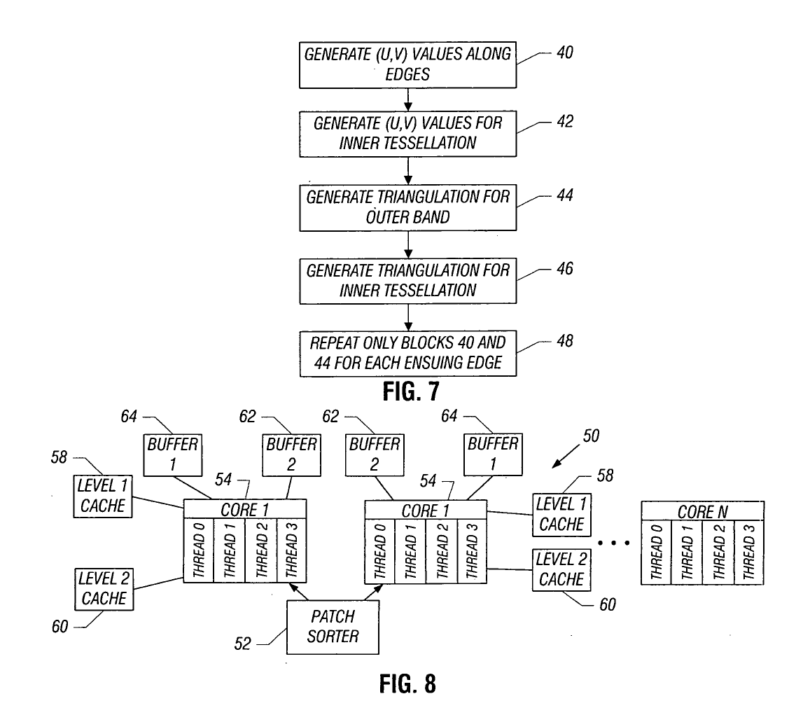

In some embodiments, the patches may be sorted, based on their inner tessellation factor, using threading and vectorizing. The patches with the same level of detail are then tessellated on the same physical core of a multi-core processor 50, as indicated in FIG. 8. After sorting and grouping in patch sorter 52, all of the patches to be tessellated having the same inner tessellation level of detail can be sent to the same core 54 or 56 and then all the threads on that core can use only one copy in the core's level one 58 and level two 60 caches. The triangles can then be unsorted using the patch primitive ID at a later point. The outer band tessellation is variable, both in terms of the number of points generated in the triangulation. Thus, a dual buffer approach may be used by placing, in the first buffer 62, the known inner tessellations that were pre-computed. Then the outer tessellation variable part is calculated and stored in the second buffer 64. While only two cores are depicted in FIG. 8, any number of cores may be used.

In accordance with one embodiment, the pseudo code may be implemented as follows:

```
PreProcess( )
{ foreach InsideTessFactor in [2..64]
    { UVBufferT[InsideTessFactor] =
CalculateUVBuffer(InsideTessFactor,TRI);
UVBufferQ[InsideTessFactor] =
CalculateUVBuffer(InsideTessFactor,QUAD);
    IndexBuffferT[InsideTessFactor]=CalculateIndexBuffer
(InsideTess Factor,TRI);
    IndexBuffferQ[InsideTessFactor]=CalculateIndexBuffer
(InsideTess Factor,QUAD);
  }
}
//Hulls shader is assumed to be done and edge LODs are
generated at this point.
void TessellatePatches( Patches )
{
  SortPatchesUsingInsideTessFactor(Patches);
  foreach InsideTessFactor (Patches.InsideTessFactors)
  {
    PatchList[InsideTessFactor] = GroupPatches(InsideTessFactor);
    TessellatePatchGroupOnOnePhysicalCore(PatchList[InsideTessFactor
]);
  }
}
//Inner Tessellations are not required until Domain Shader
execution begins
//Prefetching can be deferred until then.
void TessellatePatchGroupOnOnePhysicalCore(PatchList)
{
  PrefetchInnerUVBuffer( );
  PrefetchInnerIndexBuffer( );
  ThreadPatchGroupOnFibers( );
  TessellateOuterBands( );
}
```

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
performing a tessellation whose tessellation time increases linearly with increasing tessellation level of detail.

2. The method of claim 1 including using a software tessellator.

3. The method of claim 1 including pre-computing inner tessellation values for a plurality of different edge levels of detail before run time.

4. The method of claim 3 including looking up the pre-computed inner tessellation values at run time.

5. The method of claim 4 including pre-computing the triangulation of the inner tessellation.

6. The method of claim 1 including using 1-axis inner tessellation factor axis reduction.

7. The method of claim 1 including using a quad as the primitive domain for the tessellation.

8. The method of claim 1 including sorting and grouping patches with the same edge level of detail on separate physical cores.

9. The method of claim 8 including threading and vectorizing.

10. An apparatus comprising:
a hull shader; and
a tessellator coupled to said hull shader to form a tessellation whose tessellation time increase linearly with increasing tessellation level of detail.

11. The apparatus of claim 10 wherein tessellator is a software tessellator.

12. The apparatus of claim 10 wherein said tessellator to pre-compute inner tessellation values for a plurality of different edge levels of detail before run time.

13. The apparatus of claim 12, said tessellator to look up the pre-computed inner tessellation values at run time.

14. The apparatus of claim 13, said tessellator to pre-compute the triangulation of the inner tessellation.

15. The apparatus of claim 10, said tessellator to use 1-axis inner tessellation factor axis reduction.

16. The apparatus of claim 10, said tessellator to use as a primitive domain a quad.

17. The apparatus of claim 10, said tessellator to sort in group patches with the same edge level of detail on separate physical cores of a multi-core processor.

18. The apparatus of claim 17, said tessellator to use threading and vectorizing.

19. A system comprising:
a multi-core processor including at least two cores, each of said cores including a first and second buffer;
a patch sorter to sort patches for tessellation based on their edge level of detail and to provide the patches having the same level of detail to the same core; and
a tessellator to tessellate said patches by pre-computing the intervals and triangulation for the inner tessellations and applying the pre-computed intervals and triangulations during run time using a look up technique.

20. The system of claim 19 using threading and vectorizing.

21. The system of claim 19, said system to perform tessellations where the tessellation time increases linearly with increasing tessellation level of detail.

22. The system of claim 10 including a software tessellator.
